(19) United States
(12) Patent Application Publication
(10) Pub. No.: US 2007/0289175 A1
(43) Pub. Date: Dec. 20, 2007

(54) Locking assembly for plate-like article

(76) Inventor: Joseph R. Blodgett JR., Mount Airy, MD (US)

Correspondence Address: BERENATO, WHITE & STAVISH, LLC, 6550 ROCK SPRING DRIVE, SUITE 240, BETHESDA, MD, 20817, US

(21) Appl. No.: 11/401,975

(22) Filed: Apr. 12, 2006

(51) Int. Cl. G09F 7/00

(52) U.S. Cl. 40/201

(57) ABSTRACT

A plate-like article is mounted to a support member with a locking assembly provided for preventing unauthorized removal of the plate-like article from the support member. The locking assembly comprises a locking fastener including an elongated shank portion having an annular groove unitary formed therein adjacent to a first end thereof, and a key-operated lock unit provided for releasably engaging the annular groove of the locking fastener. The shank portion of the locking fastener extends through a mounting hole in the plate-like article. The lock unit is switchable between a locked position wherein the lock unit engages the annular groove of the locking fastener and unlocked position wherein the lock unit disengaged from the annular groove of the locking fastener. The lock unit defines a substantially cylindrical bore provided for receiving the locking fastener therein including the first end of the shank portion and the annular groove.

### BACKGROUND OF THE INVENTION

1. Field of the Invention

The present invention relates to locking devices in general, and more particularly, to a locking assembly for preventing unauthorized removal of a plate-like article from a support member.

2. Description of the Prior Art

The theft of plate-like articles, such as license plates from motor vehicles and/or trailers is becoming more and more common, especially in urban areas, and is creating an acute problem not only for an owner of a motor vehicle, but also for the government agencies responsible for registration of vehicles and maintaining records correlating a particular license plate number to a specific vehicle. Particularly, the theft of the license plates constitutes a form of identity theft, because the stolen license plate can be used to falsify the identity of another vehicle using the stolen license plate and incur legal issues for the victim of the theft, such as red camera tickets, toll booth charges or the like.

Typically, license plates are generally fastened to the motor vehicle simply by a number of screws or bolts and nut assemblies or screws, which are readily removable. As a result, unauthorized removal and theft of the license plate is easily accomplished.

Although the prior art has recognized the problem of protecting the license plate from unauthorized removal, the proposed solutions have to date been ineffective in providing a satisfactory remedy in a simple, efficient and inexpensive manner, and such assemblies are susceptible to improvements that may enhance their performance and lower cost. With this in mind, a need exists to develop a new and improved locking assembly for plate-like articles that advance the art.

### SUMMARY OF THE INVENTION

According to a first aspect of the present invention, there is provided a locking assembly comprising a locking fastener and a key-operated lock unit provided for releasably engaging the locking fastener.

The locking fastener includes an elongated shank portion adapted to extend through a mounting hole in a plate-like article. The shank portion has first and second ends and is provided with an annular groove unitary formed therein adjacent to the first end thereof. The key-operated lock unit is provided for releasably engaging the annular groove of the shank portion of the locking fastener in order to prevent access to the first end of the shank portion. The lock unit is switchable between a locked position wherein the lock unit engages the annular groove of the locking fastener and unlocked position wherein the lock unit is disengaged from the annular groove of the locking fastener. The lock unit defines a substantially cylindrical bore provided for receiving a part of the shank portion of the locking fastener including the first end and the annular groove of the shank portion.

According to a second aspect of the present invention, there is provided a plate-like article mounted to a support member in combination with a locking assembly provided for preventing unauthorized removal of the plate-like article from the support member.

The plate-like article has at least one mounting hole therethrough. The locking assembly comprises a locking fastener and a key-operated lock unit provided for releasably engaging the locking fastener. The locking fastener includes an elongated shank portion adapted to extend through the mounting hole in the plate-like article. The shank portion has first and second ends and is provided with an annular groove unitary formed therein adjacent to the first end thereof The key-operated lock unit is provided for releasably engaging the annular groove of the shank portion of the locking fastener for preventing access to the first end of the shank portion. The lock unit is switchable between a locked position wherein the lock unit engages the annular groove of the locking fastener and an unlocked position wherein the lock unit is disengaged from the annular groove of the locking fastener. The lock unit defines a substantially cylindrical bore provided for receiving a part of the shank portion of the locking fastener therein including the first end of the shank portion and the annular groove.

Therefore, the locking assembly of the present invention ensures that the plate-like article cannot be readily removed from the support member, thus prevents unauthorized removal and use of the plate-like article. As a result, it will no longer be easy for a thief to steal the plate-like article and the problem and inconvenience heretofore presented to owner and the appropriate government agencies will be substantially reduced or eliminated. Moreover, the locking assembly of the present invention may be easily installed without requiring physical modifications of the plate-like article or the supporting member in which the plate-like article is attached.

### BRIEF DESCRIPTION OF THE DRAWINGS

Other objects and advantages of the invention will become apparent from a study of the following specification when viewed in light of the accompanying drawings, wherein:

FIG. 1 is a partial front view of a license plate mounted on a bumper of a vehicle with a license plate locking assembly according to a first exemplary embodiment of the present invention;

FIG. 2 is a partial side view of the license plate mounted on the bumper of the vehicle with the license plate locking assembly according to the first exemplary embodiment of the present invention;

FIG. 3 is a front view of the license plate of the vehicle;

FIG. 4A is a partial sectional view of the license plate mounted on the bumper of the vehicle with the license plate locking assembly according to the first exemplary embodiment of the present invention in an unlocked position;

FIG. 4B is a partial sectional view of the license plate mounted on the bumper of the vehicle with the license plate locking assembly according to the first exemplary embodiment of the present invention in a locked position;

FIG. 5 is a side view of a locking fastener according to the first exemplary embodiment of the present invention;

FIG. 6 is perspective view of a key-operated lock unit of the present invention;

FIG. 7 is side view of the key-operated lock unit of the present invention;

FIG. 8 is cross-sectional view of the key-operated lock unit of the present invention taken along the line 8-8 shown in FIG. 6;

FIG. 9 is an exploded elevation view of the license plate mounted on the bumper of the vehicle with the license plate locking assembly according to the first exemplary embodiment of the present invention;

FIG. 10 is a partial front view of the license plate mounted on a mounting bracket of a vehicle with a license plate locking assembly according to a second exemplary embodiment of the present invention;

FIG. 11 is a side view of the license plate mounted on the mounting bracket of the vehicle with the license plate locking assembly according to the second exemplary embodiment of the present invention;

FIG. 12 is a sectional view of the license plate mounted on the mounting bracket of the vehicle with the license plate locking assembly according to the second exemplary embodiment of the present invention in a locked position;

FIG. 13 is a side view of a locking fastener according to the second exemplary embodiment of the present invention;

FIG. 14 is an exploded elevation view of the license plate mounted on the mounting bracket of the vehicle with the license plate locking assembly according to the second exemplary embodiment of the present invention;

FIG. 15 is a side view of the license plate mounted on the mounting bracket of the vehicle with the license plate locking assembly according to the alternative embodiment of the present invention.

### DETAILED DESCRIPTION OF PREFERRED EMBODIMENT

The preferred embodiments of the present invention will now be described with the reference to accompanying drawings.

For purposes of the following description, certain terminology is used in the following description for convenience only and is not limiting. The words such as “right”, “left”, “up”, “down” and “side” designate directions in the drawings to which reference is made. The words “smaller” and “larger” refer to relative size of elements of the apparatus of the present invention and designated portions thereof. The terminology includes the words specifically mentioned above, derivatives thereof and words of similar import. Additionally, the word “a”, as used in the claims, means “at least one”.

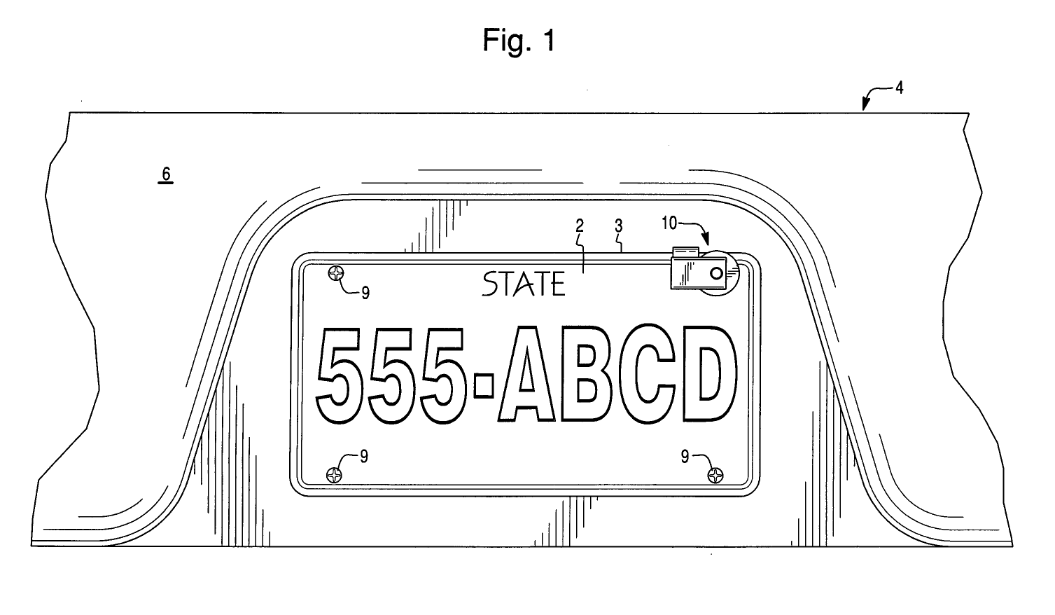

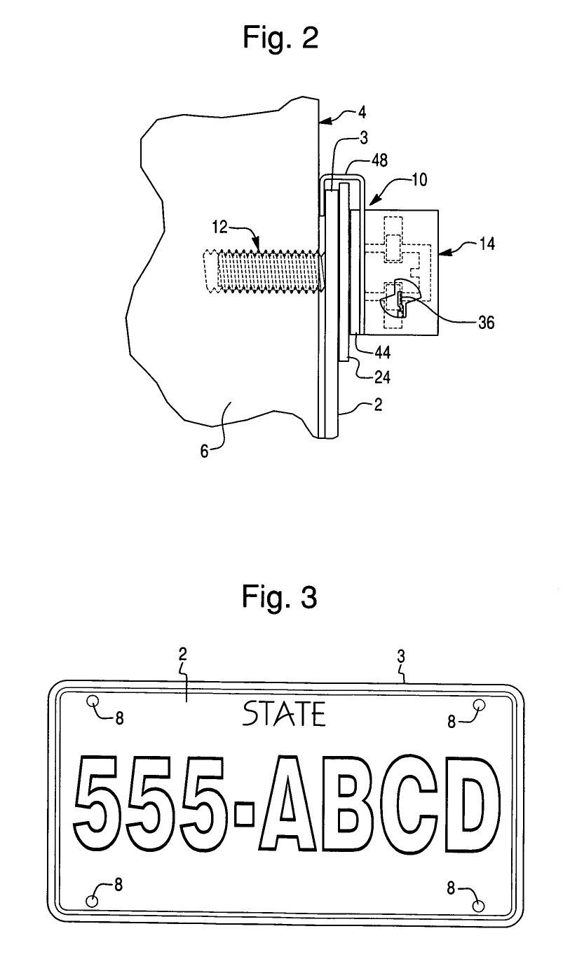

FIGS. 1 and 2 depict a conventional, rectangular license plate 2 mounted to a vehicle 4 according to a first exemplary embodiment of the present invention. More specifically, according to the first exemplary embodiment, the license plate 2 is fastened to a license plate support member, such as a bumper 6 of the vehicle 4. Typically, the license plate 2 has four mounting holes 8 therethrough formed at each of four corners thereof, as shown in FIG. 3. As further illustrated in FIGS. 1 and 2, the license plate 2 is attached to the bumper 4 by three conventional fasteners 9 and a locking assembly 10. Preferably, the fasteners 9 are in the form of threaded fasteners, such as screws or bolts. It will be appreciated that any appropriate fasteners used for securing the license plate 2 to the bumper 4 are within the scope of the present invention. The three threaded fasteners 9 extend through the corresponding three mounting holes 8 in the license plate 2 and threadedly engage the bumper 6 of the vehicle 4.

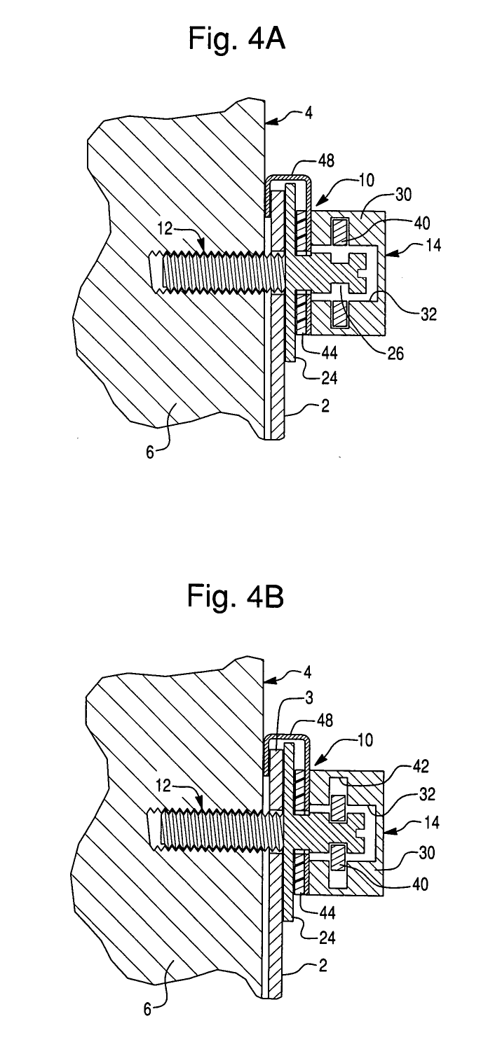

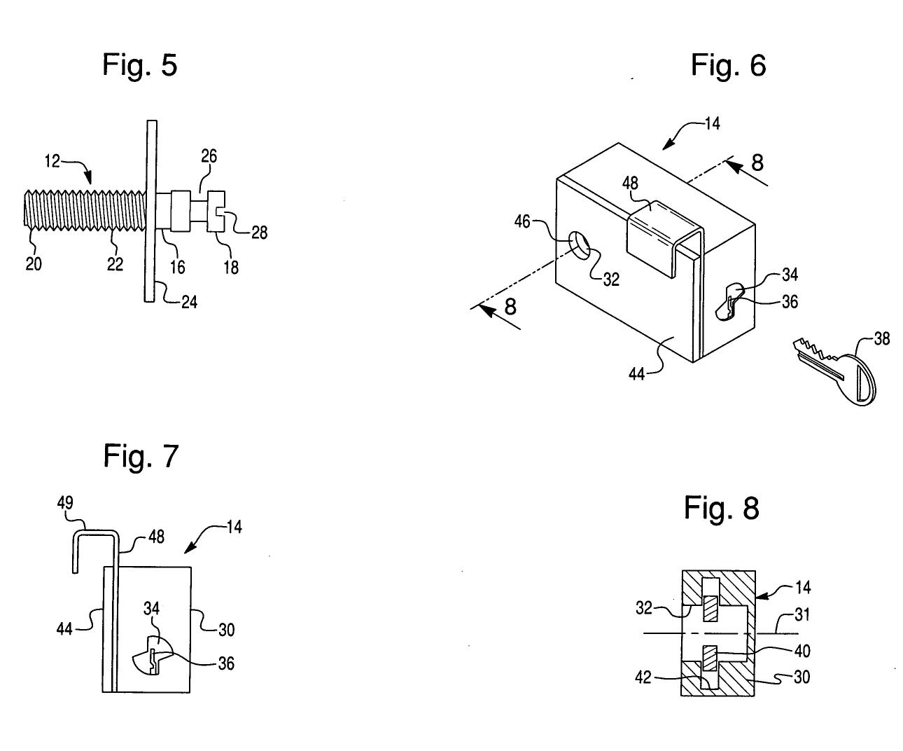

The locking assembly 10 according to the first exemplary embodiment of the present invention illustrated in FIGS. 4A and 4B, comprises a locking fastener 12 and a key-operated lock unit 14 provided for releasably engaging the locking fastener 12 for preventing access to thereto in order to provide for security from tampering with the locking fastener 12. The locking fastener 12 illustrated in detail in FIG. 5, includes an elongated shank portion 16 having first and second distal ends 18 and 20, respectively. As illustrated in FIG. 4, the shank portion 16 of the locking fastener 12 extends through the fourth mounting hole 84 in the license plate 2. As further illustrated in detail in FIG. 5, the shank portion 16 is also provided with a threaded segment 22 adjacent to the second end 20 thereof for threadedly engaging the bumper 6 of the vehicle 4, as shown in FIGS. 2, 4A and 4B. Preferably, the threaded segment 22 is provided with a standard ¼″ course thread.

According to the first exemplary embodiment of the present invention, the shank portion 16 of the locking fastener 12 also includes a support flange 24 oriented substantially orthogonally to the shank portion 16 and disposed between the license plate 2 and the bumper 4. Preferably, the support flange 24 is substantially circular and is formed integrally with the shank portion 16. In other words, the support flange 24 is rigidly fixed to the shank portion 16, such as by welding, adhesive bonding, etc, or formed unitarily therewith, as shown in FIG. 5. Alternatively, as illustrated in FIG. 14, the support flange may be threadedly mounted to the threaded segment of the shank portion of the locking fastener so as to be adjustably movable axially along the shank portion of the locking fastener. The support flange 24 is disposed between the first and second ends 18,20 of the shank portion 16 at the right side end of the threaded segment 22. Furthermore, the shank portion 16 of the locking fastener 12 is provided with an annular groove 26 unitary formed therein adjacent to the first end 18 of the shank portion 16.

A driving recess 28 is formed on the first end 18 of the shank portion 16 for insertion of a tool (not shown), such as screwdriver, to apply a driving force. The driving recess 28 can be designed to be different in shape and configuration. Preferably, the driving recess 28 on the first end 18 of the shank portion 16 is in the form of a driver slot or Phillips one. Alternatively, the driving recess 28 may also be with a triangle, square, hexagonal, or any other multi-angular form in section. Further alternatively, the first end 18 may have a polygonal outer peripheral surface, such as hexagonal, for engaging a conventional wrench tool.

The key-operated lock unit 14 according to the first exemplary embodiment of the present invention illustrated in FIGS. 2, 4 and 6-8, is provided for releasably engaging the annular groove 26 of the shank portion 16 of the locking fastener 12 in order to secure the license plate 2 to the vehicle 4 and prevent access to the first end 18 of the shank portion 16, thus prevent theft of the license plate 2. The lock unit 14 includes a casing 30 defining a substantially cylindrical blind bore 32 therein having a central axis 31, as shown in detail in FIG. 8. The bore 32 is provided for removably receiving therein a part of the shank portion 16 of the locking fastener 12 including the first end 1 8 of the shank portion 16 and the annular groove 26. The lock unit 14 further includes a key-operated locking mechanism 34 disposed within the casing 30 and having a key slot 36 adapted to receive a key 38 operating the locking mechanism 34, as illustrated in FIGS. 6 and 7. Preferably, the locking mechanism 34 includes a locking tab 40 radially movable in and out of a slot portion 42 formed in the bore 32 for retaining the locking tab 40, as shown in FIG. 8. It will be appreciated that the locking mechanism 34 may of any appropriate type known in the art.

The lock unit 14 is switchable by the key 38 between a locked position (shown in FIGS. 2 and 4B) wherein the lock unit is engaged with the annular groove 26 of the locking fastener 12 and an unlocked position (shown in FIG. 4A) wherein the lock unit 14 is disengaged from the annular groove 26 of the locking fastener 12. More specifically, in the locked position shown in FIG. 4B, the locking tab 40 is shifted out of the slot portion 42 of the bore 40 of the casing 30 and into engagement with the groove 26 in the locking fastener 12. Conversely, in the unlocked position shown in FIG. 4A, the locking tab 40 is shifted into the slot portion 42 and out of engagement with the groove 26 in the locking fastener 12.

Furthermore, the lock unit 14 is provided with a cover plate 48 fixed to the casing 30 at one end thereof. As illustrated in FIGS. 6 and 7, the other end of the cover plate 48 has a U-shaped portion (or hook portion) 49 provided for engaging a peripheral edge 3 of the license plate 2, as shown in FIGS. 1, 2, 4A and 4B.

Moreover, the locking assembly 10 according to the first exemplary embodiment of the present invention, comprises a gasket 44 disposed between the license plate 2 and the lock unit 14, as shown in FIGS. 2, 4A and 4B. The gasket 44 could be made of any appropriate elastomeric material, such as rubber. As illustrated, the gasket 44 has a through hole 46 having a substantially same diameter as the bore 32 in the casing 30. Preferably, the gasket 44 is fixed to a side surface of the casing 30 of the lock unit 14 facing the license plate 2 so that the hole 46 is positioned substantially coaxially to the bore 32 in the casing 30.

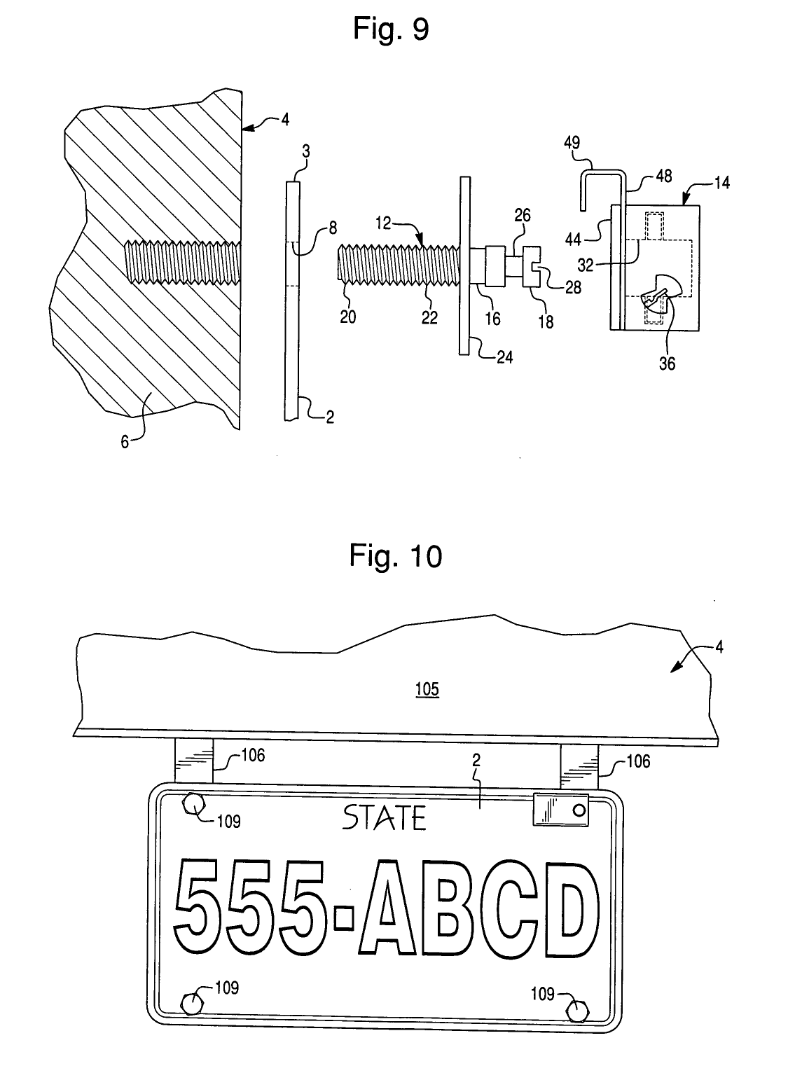

An example of a process of mounting the license plate 2 to the bumper 6 of the vehicle 4, illustrated in FIG. 9, is as follow.

First, the license plate 2 is secured to the bumper 6 of the vehicle 4 by the three threaded fasteners 9 extending through the corresponding three mounting holes 8 in the license plate 2 and the locking fastener 12 extending through the fourth mounting hole 8 in the license plate 2. More specifically, the second end 20 of the shank portion 16 of the locking fastener 12 is inserted into the fourth mounting hole 8 so that the license plate 2 is placed between the bumper 6 and the support flange 24 of the locking fastener 12. Subsequently, the threaded segment 22 of the shank portion 16 is threaded into the bumper 6 of the vehicle 4. The locking fastener 12 is tightened by the appropriate screwdriver (not shown) engaging the driving recess 28 on the first end 18 of the shank portion 16 until the license plate 2 is firmly sandwiched between the bumper 6 and the support flange 24 of the locking fastener 12.

Then, the key 38 is inserted into the key slot 36 of the locking mechanism 34 of the lock unit 14 and turned so as to place the lock unit 14 into the unlocked position. Next, the lock unit 14 is mounted to the locking fastener 12 so that the U-shaped portion 49 of the cover plate 48 engages the periphery of the license plate 2, as shown in FIGS. 1, 2, 4A and 4B, and a part of the shank portion 16 of the locking fastener 12 including the first end 18 thereof and the annular groove 26 is received into the bore 32 in the lock unit 14.

Subsequently, the key 38 is turned so as to place the lock unit 14 into the locked position in which the locking tab 40 is shifted out of the slot portion 42 of the bore 40 of the casing 30 to project directly into the bore 32 and into engagement with the groove 26 in the locking fastener 12, thus, firmly securing the lock unit 14 to the locking fastener 12.

Finally, the key 38 is removed from the key slot 36. It is apparent that the locking assembly 10 prevents unauthorized removal of the lock unit 14 from the locking fastener 12, therefore securely locking the license plate 2 to the bumper 6 of the vehicle 4.

FIGS. 10-14 of the drawings illustrate a second exemplary embodiment of a locking assembly of the present invention, generally depicted with the reference numeral 110. Components, which are unchanged from, or function in the same way as in the first exemplary embodiment depicted in FIGS. 1-10 are labeled with the same reference numerals, sometimes without describing detail since similarities between the corresponding parts in the two embodiments will be readily perceived by the reader.

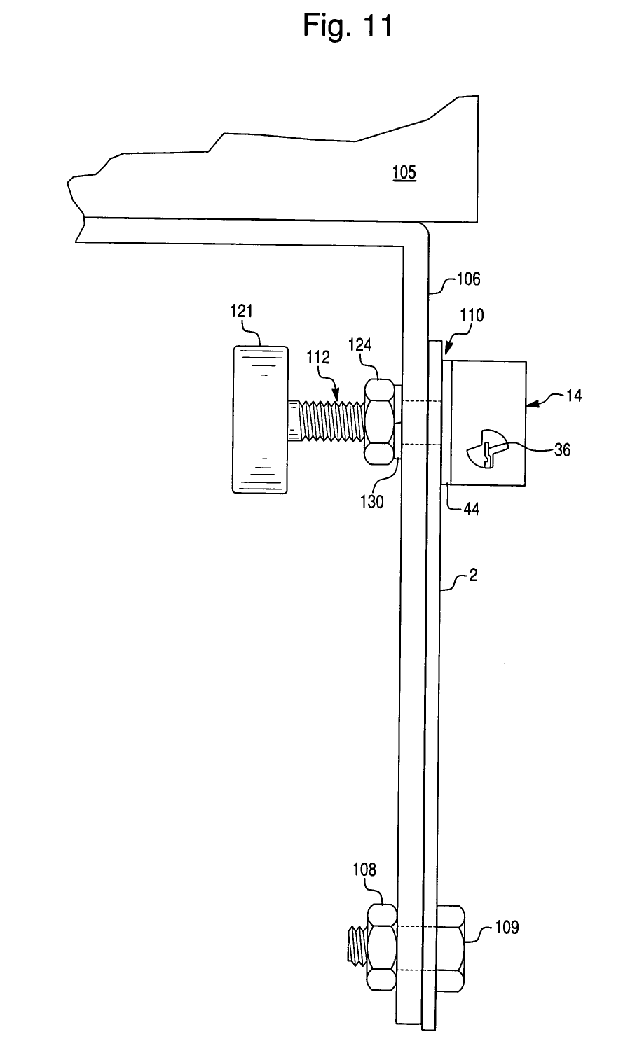

FIGS. 10 and 11 depict a conventional, rectangular license plate 2 mounted to a vehicle 4 according to the second exemplary embodiment of the present invention. More specifically, according to the second exemplary embodiment, the license plate 2 is fastened to a license plate support member, such as a mounting bracket 106 downwardly extending from a body 105 of the vehicle 4, such as trailer or recreational vehicle (RV). The mounting bracket 106 has a front face 106f facing the license plate 2, and a rear face 106r opposite the front face 106f. The mounting bracket 106 is further provided with four mounting holes 107 therethrough formed to coincide with the four mounting holes 8 in the license plate 2. As further illustrated in FIGS. 10 and 11, the license plate 2 is attached to the mounting bracket 106 by three conventional fasteners, and the locking assembly 110. Preferably, the fasteners are in the form of threaded fasteners, such as bolts 109 and nuts 108. The bolts 109 extend through the corresponding mounting holes 8 in the license plate 2 and threadedly engage the nuts 108.

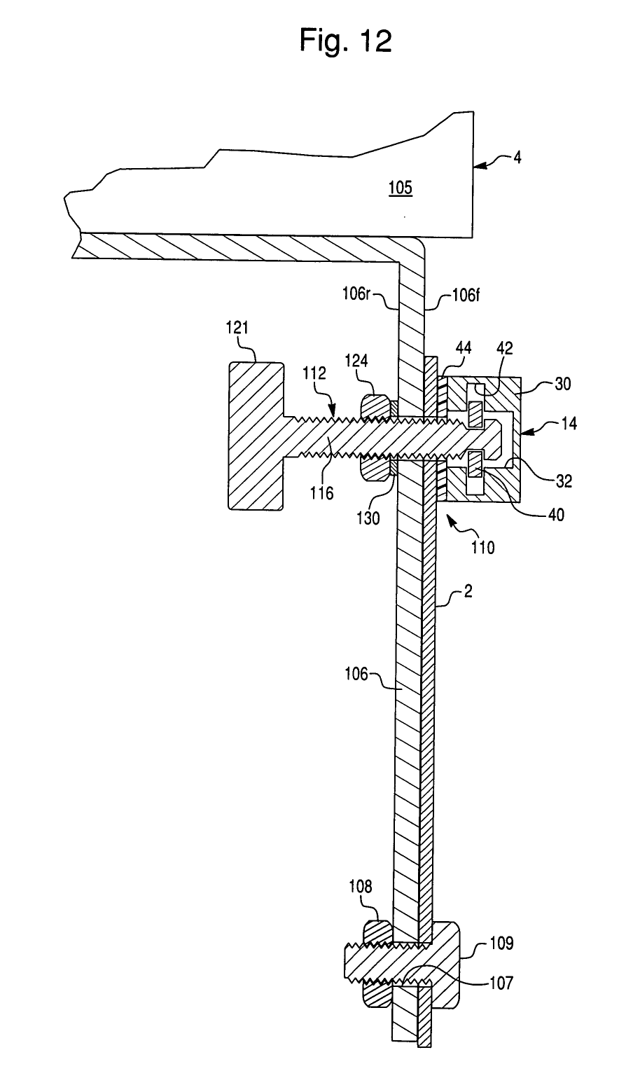

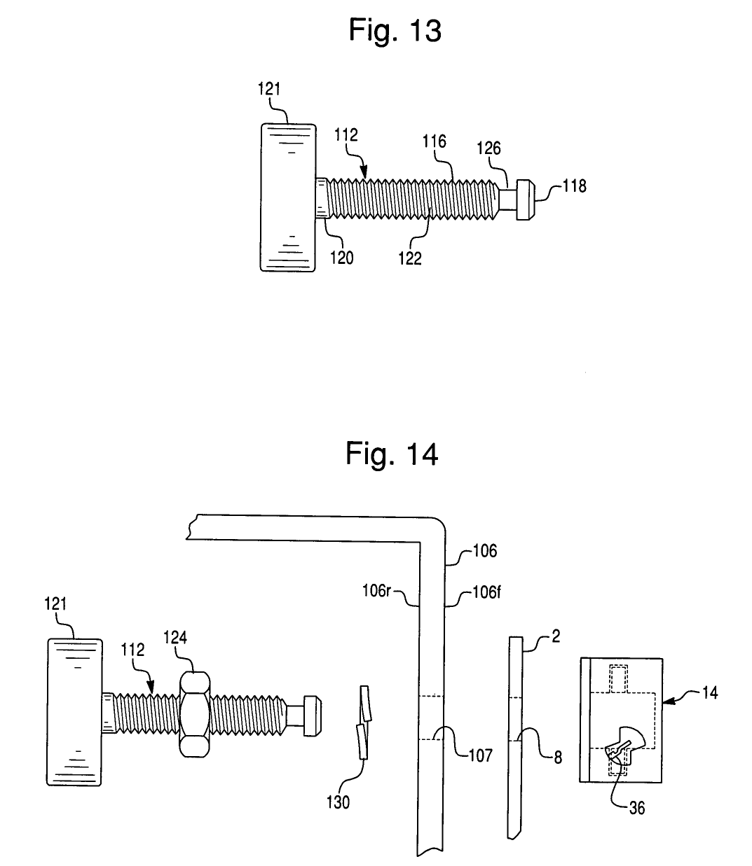

The locking assembly 110 according to the second exemplary embodiment of the present invention illustrated in detail in FIG. 12, comprises a locking fastener 112 and a key-operated lock unit 14 provided for releasably engaging the locking fastener 1 12 for preventing access to thereto in order to provide for security from tampering with the locking fastener 112. The locking fastener 112 illustrated in detail in FIG. 13, includes an elongated shank portion 1 16 extending from an enlarged head portion 121. The shank portion 116 has a distal first end 118 and a second end 120 adjacent to the head portion 121 of the locking fastener 112. As illustrated in FIG. 12, the shank portion 116 of the locking fastener 112 extends through the fourth mounting hole 8 in the license plate 2. As further illustrated in detail in FIG. 13, the shank portion 116 is also provided with a threaded segment 122 adjacent to the second end 120 thereof.

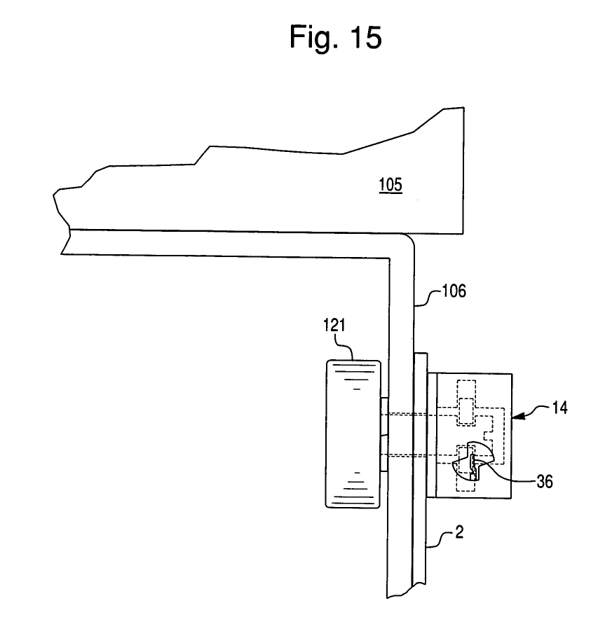

The shank portion 116 of the locking fastener 112 is further provided with an annular groove 126 unitary formed therein adjacent to the first end 118 of the shank portion 116. According to the second exemplary embodiment of the present invention, the shank portion 116 of the locking fastener 112 also includes an adjustable support flange 124 in the form of a nut threadedly engaging the threaded segment 122 of the shank portion 116 so as to be adjustably movable axially along the shank portion 116 of the locking fastener 112 between the first and second ends 118, 120 thereof. Such an arrangement of the locking fastener 112 allows for a universal license plate locking assembly adapted to be used with different vehicles having various sizes of the mounting brackets. Alternatively, the locking fastener 112 may have a length tailored for a specific vehicle(s) it designed to be employed with, thus alleviating the need for the adjustable support flange 124 and threads on the shank portion 116, as shown in FIG. 15. An example of a process of mounting the license plate 2 to the mounting bracket 106 of the vehicle 4, illustrated in FIG. 14, is as follow.

First, the license plate 2 is mounted to the mounting bracket 106 of the vehicle 4 by the three pairs of bolts 109 and nuts 108. More specifically, the three bolts 109 extend through the corresponding three mounting holes 8 in the license plate 2 and the corresponding three mounting holes 107 in the mounting bracket 106. The bolts 109 are then secured by the nuts 108.

Then, the adjustable support flange 124 is rotated on the shank portion 16 so as to move it toward the head portion 121 of the locking fastener 112 adjacent to the second end 120 thereof. Next, the first end 118 of the shank portion 116 of the locking fastener 112 is inserted into the fourth mounting hole 107 in the mounting bracket 106 through the rear face 107r thereof and the fourth mounting hole 8 of the license plate 2 so that the adjustable support flange 124 is positioned between the head portion 121 of the locking fastener 112 and the mounting bracket 106. Moreover, as illustrated in FIGS. 11, 12 and 14, a spring washer 130 is placed between the adjustable support flange 124 and the mounting bracket 106.

After that, the key 38 is inserted into the key slot 36 of the locking mechanism 34 of the lock unit 14 and turned so as to place the lock unit 14 into the unlocked position. Next, the lock unit 14 is mounted to the locking fastener 112 so that a part of the shank portion 116 of the locking fastener 112 including the first end 118 thereof and the annular groove 126 is received into the bore 32 in the lock unit 14. Subsequently, the key 38 is turned so as to place the lock unit 14 into the locked position in which the locking tab 40 is shifted out of the slot portion 42 of the bore 40 of the casing 30 to project directly into the bore 32 and into engagement with the groove 126 in the locking fastener 112, thus, firmly securing the lock unit 14 to the locking fastener 112. Afterward, the key 38 is removed from the key slot 36.

Finally, the adjustable support flange 124 is rotated on the shank portion 16 so as to tighten by an appropriate tool (such as wrench) until the license plate 2 is firmly sandwiched between the mounting bracket 106 and the lock unit 14 due to resilience of the spring washer 130 and the elastomeric gasket 44. As illustrated in FIGS. 11 and 12, the spring washer 130 is compressed between the adjustable support flange 124 and the mounting bracket 106, while the elastomeric gasket 44 is compressed between the license plate 2 and the lock unit 14. It is apparent that the locking assembly 110 prevents unauthorized removal of the lock unit 14 from the locking fastener 112, therefore securely locking the license plate 2 to the mounting bracket 106 of the vehicle 4.

It will be appreciated that the process of mounting the license plate 2 to the mounting bracket 106 of the vehicle 4 using the locking assembly 110 without the adjustable support flange 124, illustrated in FIG. 15, lacks the step of adjusting the position of the adjustable support flange 124 on the shank portion 16 so as to firmly sandwich the license plate 2 between the mounting bracket 106 and the lock unit 14.

It will also be appreciated that the locking assembly (10 or 110) of the present invention may be used with any conventional license plate frame.

While the present invention is described in relation to the locking assembly for preventing unauthorized removal and use of the license plate of the vehicle, it is to be understood that the locking assembly of the present invention may be used for locking any other appropriate plate-like articles, such as street signs, road signs or corporate signs, attached to either a post or a wall.

From the above description it is readily apparent that the locking assembly of the present invention ensures that a plate-like article cannot be readily removed from a support member, therefore prevents unauthorized removal and use thereof t. As a result, it will no longer be easy for a thief to steal the plate-like article, such as a license plate, a road sign or a street sign, and the problem and inconvenience heretofore presented to the owner of the plate-like article and the appropriate government agencies will be substantially reduced or eliminated. Moreover, the locking assembly of the present invention may be easily installed without requiring physical modifications of the plate-like article or the supporting member in which the plate-like article is attached.

The foregoing description of the preferred embodiment of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiment disclosed hereinabove was chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A locking assembly for a plate-like article, said locking assembly comprising:
a locking fastener having an elongated shank portion adapted to extend through a mounting hole in said plate-like article to be locked, said shank portion having first and second ends and provided with an annular groove unitary formed therein adjacent to said first end thereof;
a key-operated lock unit provided for releasably engaging said annular groove of said shank portion of said locking fastener in order to prevent access to said first end of said shank portion;
said lock unit switchable between a locked position wherein said lock unit engaged with said annular groove of said locking fastener and an unlocked position wherein said lock unit disengaged from said annular groove of said locking fastener;
said lock unit defining a substantially cylindrical bore provided for receiving a part of said shank portion of said locking fastener including said first end and said annular groove of said shank portion.

2. The locking assembly as defined in claim 1, wherein said locking fastener includes a support flange disposed about said shank portion between said annular groove and said second ends thereof.

3. The locking assembly as defined in claim 2, wherein said support flange is oriented substantially orthogonally to said shank portion of said locking fastener.

4. The locking assembly as defined in claim 2, wherein said support flange is formed integrally with said shank portion between said annular groove and said second ends thereof

5. The locking assembly as defined in claim 1, wherein said shank portion is provided with a threaded segment adjacent to said second end thereof.

6. The locking assembly as defined in claim 2, wherein said support flange threadedly engages said shank portion so as to be adjustably movable axially along said shank portion of said locking fastener between said annular groove and said second ends thereof.

7. The locking assembly as defined in claim 1, further comprising a gasket secured to a side surface of said lock unit facing said locking fastener; said gasket is made of an elastomeric material.

8. The locking assembly as defined in claim 1, wherein said plate-like article is one of a license plate of a vehicle, a road sign and a street sign.

9. The locking assembly as defined in claim 1, further comprising a cover plate attached to said lock unit; a distal end of said cover plate has a U-shaped portion provided for engaging a peripheral edge of said plate-like article.

10. The locking assembly as defined in claim 1, wherein said locking fastener further includes an enlarged head portion disposed adjacent to said second end of said shank portion.

11. In combination, a plate-like article mounted to a support member and a locking assembly provided for preventing unauthorized removal of said plate-like article from said support member; said plate-like article having at least one mounting hole therethrough; said locking assembly comprising:
a locking fastener having an elongated shank portion extending through said at least one mounting hole in said plate-like article and through said support member of said vehicle, said shank portion having first and second ends and provided with an annular groove unitary formed therein adjacent to said first end thereof;
a key-operated lock unit provided for releasably engaging said annular groove of said shank portion of said locking fastener for preventing access to said first end of said shank portion;
said lock unit switchable between a locked position wherein said lock unit engaged with said annular groove of said locking fastener and an unlocked position wherein said lock unit disengaged from said annular groove of said locking fastener;
said lock unit defining a substantially cylindrical bore provided for receiving a part of said shank portion of said locking fastener therein including said first end of said shank portion and said annular groove.

12. The combination as defined in claim 1, wherein said locking fastener includes a support flange disposed about said shank portion between said first and second ends thereof.

13. The combination as defined in claim 12, wherein said support flange is oriented substantially orthogonally to said shank portion of said locking fastener.

14. The combination as defined in claim 12, wherein said support flange is formed integrally with said shank portion between said annular groove and said second ends thereof

15. The combination as defined in claim 11, wherein said shank portion is provided with a threaded segment adjacent to said second end thereof.

16. The combination as defined in claim 12, wherein said support flange threadedly engages said shank portion so as to be adjustably movable axially along said shank portion of said locking fastener between said first and second ends thereof.

17. The combination as defined in claim 11, further comprising a gasket secured to a side surface of said lock unit facing said plate-like article; said gasket is made of an elastomeric material.

18. The combination as defined in claim 11, further comprising a cover plate attached to said lock unit; a distal end of said cover plate has a U-shaped portion engaging a peripheral edge of said plate-like article.

19. The combination as defined in claim 11, wherein said locking fastener further includes an enlarged head portion disposed adjacent to said second end of said shank portion.

20. The combination as defined in claim 12, wherein said plate-like article is disposed between said support member and said support flange of said locking fastener or between said support member and said lock unit.
